(19) United States
(12) Patent Application Publication
(10) Pub. No.: US 2011/0202294 A1
(43) Pub. Date: Aug. 18, 2011

(54) High voltage impulse test system with a correction algorithm

(76) Inventors: Martin Hinow, Dresden (DE); George Hinow, Dresden (DE)

(21) Appl. No.: 12/931,559

(22) Filed: Feb. 4, 2011

(30) Foreign Application Priority Data
Feb. 5, 2010 (DE) 10 2010 000 332.8
Nov. 4, 2010 (DE) 10 2010 060 338.4

(51) Int. Cl. G06F 19/00

(52) U.S. Cl. 702/64

(57) ABSTRACT

A correction algorithm is used in order to reduce the systematic measurement error arising from the evaluation device of an impulse voltage test system. It is advantageous to install the high-voltage divider as intermediate circuit. This arrangement requires only one high-voltage connection between the components of the test system and the device under test. The correction function u_{K}(t) is the difference between the voltage at the device under test u_{P}(t) and the voltage at the high-voltage divider u_{T}(t).

### CROSS REFERENCE TO RELATED APPLICATIONS

Applicants claim priority under 35 U.S.C. §119 of German Application No. 10 2010 000 332.8 filed Feb. 5, 2010 and German Application No. 10 2010 060 338.4 filed Nov. 4, 2010, the disclosures of which are incorporated by reference.

### BACKGROUND OF THE INVENTION

1. Field of the Invention

We propose an automatic high voltage impulse test system using a measurement signal interpretation device and a correction algorithm, to be applied to voltages of several MV. The goal is to reduce systematic measurement errors and to improve quality assurance of isolations.

2. Description of the Related Art

High voltage impulse test systems are used to ensure the quality of isolations of operating equipment in power engineering. International standards such as IEC 60060-1 or IEC 60060-2 stipulate the following test methods:
a. test of types, after development of new devices and classes, to ensure their correct dimensioning and realization
b. routine tests, after the production and delivery of a specimen, to guarantee the quality of manufacturing

Both tests contain high voltage tests, in particular the high voltage impulse test. The device to be tested is exposed to loads coming from the power grid, specifically lightning impulse voltages, switching impulse voltages and chopped impulse voltages.

### SUMMARY OF THE INVENTION

In this document we propose a new correction algorithm with the goal to reduce the systematic measurement error. For two configurations of the test system, namely the subsequent circuit (when the voltage divider is connected after the test object) and intermediate-circuit (when the voltage divider is placed between generator and test object) we provide correction function and difference function. The correction function u_{K}(t) is used to condition the measurement signal u_{e,Z}(t) so that the user is supplied with an ideal voltage u_{e,i}(t). A beneficial design of the invention is to use a transient-recorder which makes the use of a computer straightforward.

### BRIEF DESCRIPTIONS OF THE DRAWINGS

The following figures will elucidate the invention.

FIG. 1 is a graph containing the definitions of characteristics of an ideal lightning impulse voltage with the relevant parameters the impulse front time T₁ and the time to half value T₂.

FIG. 2 is a graph containing the definitions of characteristics of an ideal lightning impulse voltage with the relevant parameters the impulse front time T₁ and the time to half value T₂.

FIG. 3 is a graph containing the definitions of characteristics of an ideal switching impulse voltage with the relevant parameters the impulse front time T₁ and the time to half value T₂.

FIG. 4 shows a single-stage equivalent circuit diagram of an impulse voltage generator, a chopping gap, a test object, a high-voltage divider and a evaluation device, namely a transient recorder.

FIG. 5 shows an impulse voltage test system with an impulse generator, a chopping gap, a test object, a high voltage divider, which is connected as a subsequent circuit and a transient recorder.

FIG. 6 shows an impulse voltage test system with an impulse generator, a chopping gap, a test object, a high voltage divider, which is connected as an intermediate-circuit and a transient recorder.

FIG. 7 shows a single-stage equivalent circuit diagram of an impulse voltage generator, a chopping gap, a test object, a high-voltage divider which is installed as an intermediate circuit.

FIG. 8 shows the application of the correction algorithm u_{K}(t) to a voltage signal u_{e,Z}(t) which comes from a voltage divider that is installed as an intermediate-circuit. This incoming signal is transformed into an ideal voltage signal u_{e,i}(t).

### DETAILED DESCRIPTION OF THE PREFERRED EMBODIMENTS

The ideally impulse voltage is given by an increasing and a decreasing exponential function

u(t)=u₀K(e^{-t/τ2}−e^{-t/τ1})

where u₀ is the maximal charging voltage of the impulse voltage generator, k the efficiency factor and τ are the rates of increase and decrease respectively of the exponential term.

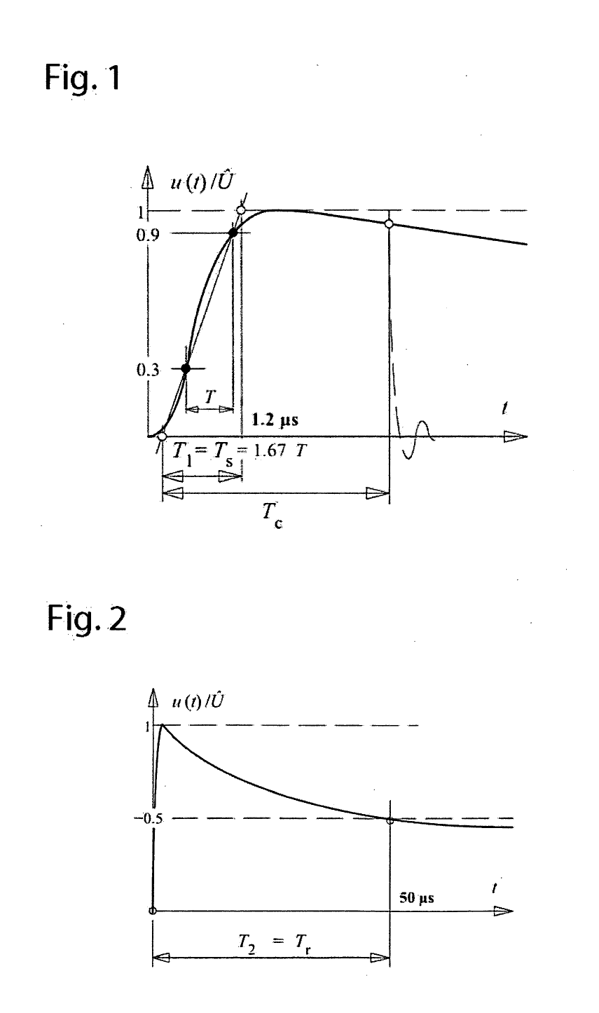

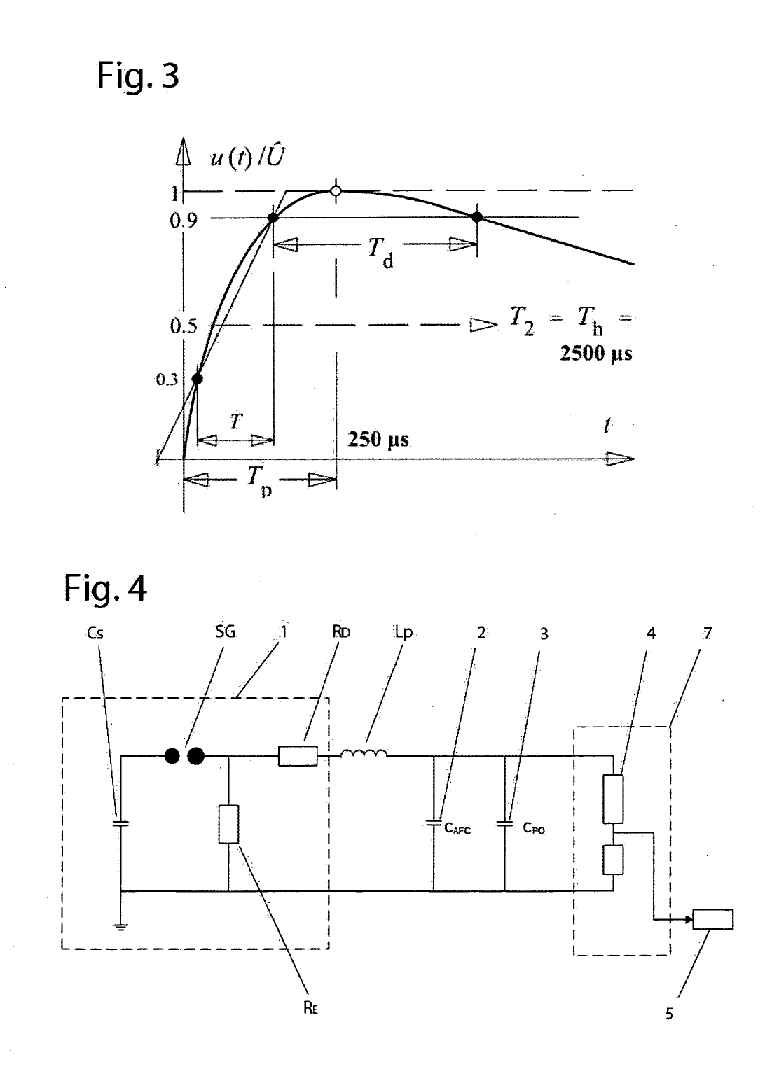

The impulse front time T₁ and the time to half value T₂ are defined in the international standard IEC 60060-1, together with their admissible tolerances. Moreover, IEC 60060-1 defines the maximally admissible overshoot voltage. FIGS. 1 and 2 show an example for an impulse voltage. Another applied impulse voltage is the so-called chopped impulse voltage. Depending on the particular application at hand, the voltage is reset to zero after the passage of 1-5 microseconds.

The impulse voltage system consists of the following components.
the surge voltage generator 1, 11, 21 or 31
optionally, a chopping gap 2, 12, 22 or 32 to chop the impulse voltage
the test object test 3, 13, 23 or 33
the high-voltage divider 4, 14, 24, 34 or 44, that transforms the measured impulse voltage uₑ(t) to a voltage <2000 V
the evaluation device 5, 15, 25, 35 or 45, most commonly a transient recorder, that records the measured voltage
optionally, an overshoot-compensation, that reduces the overshoot voltage at its peak to the admissible value.

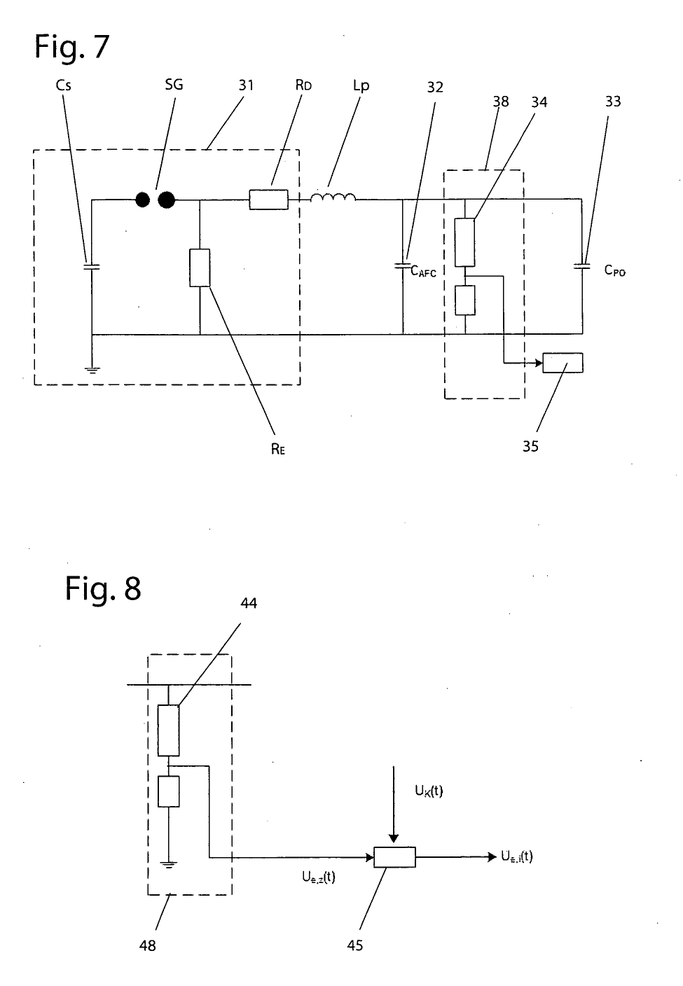

The latter compensation is a resonant circuit consisting of capacitive, inductive and ohm elements that can be integrated into the testing system as a separate component. The impulse capacitors C_{S} of the impulse voltage generator 1, 11, 21 or 31 are charged. After firing the spark gap SG, the energy stored in the capacitors is released into the remainder of the system. The damping resistor R_{D} reduces the slope of the increasing exponential function. The discharging resistor R_{E} influences the decreasing exponential function. The parasite inductances of the test circuit L_{P} causes an oscillation at the peak of the impulse function. The chopping gap 2, 12, 22 or 32 consists of a serial connection of capacitors and resistors that may further include inductive components. The high-voltage divider 4, 14, 24, 34 or 44 can be realized as an ohm, capacitive or mixed voltage divider. The test object 3, 13, 23 or 33 likewise has ohm, capacitive and inductive components. FIGS. 4 and 7 show examples of impulse voltage test system with the respective components.

Except for the positioning of the high-voltage divider 4, 14, 24, 34 or 44, the standard IEC 60060-2 does not prescribe a particular arrangement of the components. The high-voltage divider 4, 14, 24, 34 or 44 has to be placed after the test object 3, 13, 23 or 33, i. e. as subsequent circuit 7 or 17 in order to reduce the voltage measurement error. FIG. 4 shows the required arrangement of the components according to IEC 60060-2.

However, the standard IEC 60060-2 provides the following exception. The high-voltage divider 24, 34 or 44 may be placed between the impulse voltage generator 21 or 31 and the test object 23 or 33 as intermediate circuit 28 or 38, see FIG. 6 and FIG. 7, only if the resulting measurement error can be neglected. If the high-voltage divider 24, 34 or 44 is placed as intermediate circuit 28 or 38, a part of the testing current passes through it, so that the resulting measurements deviate from the ideal condition.

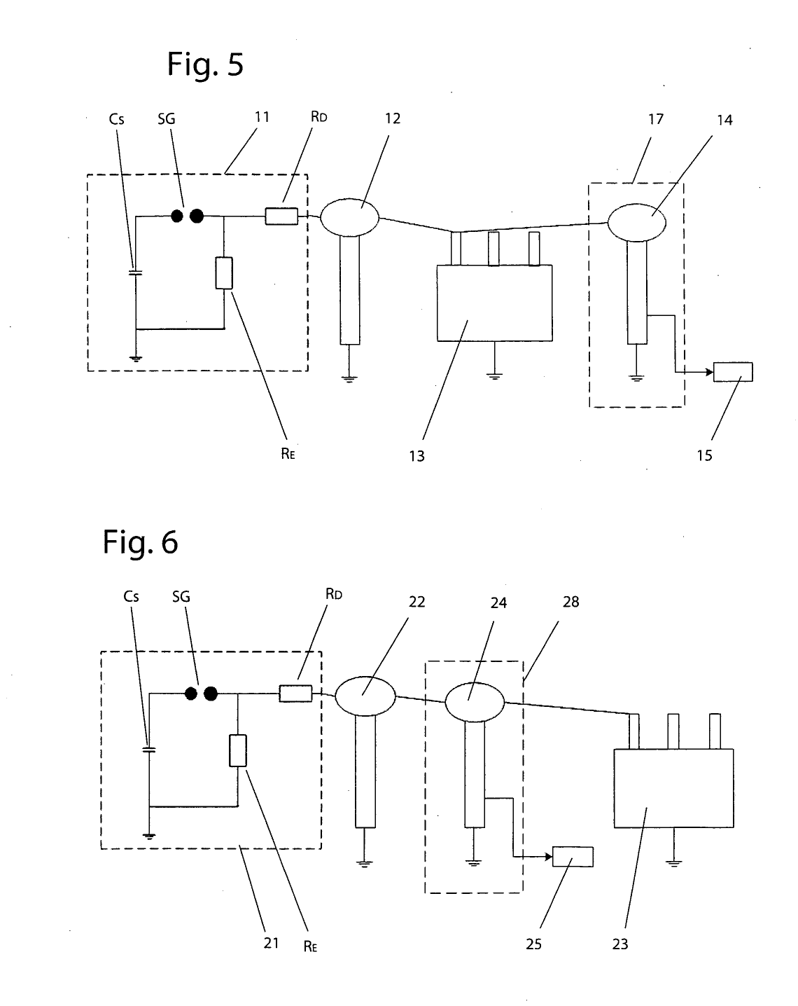

The present invention defines unequivocally the intermediate circuit 28 or 38, if the high-voltage divider 24, 34 or 44 is placed between the surge voltage generator 21 or 31 and the device under test 23 or 33, regardless of the arrangement of the remaining components, see FIGS. 6 and 7. On the other hand, the circuit 7 or 17 is uniquely defined if the high-voltage divider 4 or 14 succeeds the device under test 3 or 13, again independently of the arrangement of the remaining components, see FIG. 4 and FIG. 5.

In order to enable efficient work in the testing field, it is clearly advantageous to install the high-voltage divider 24 or 44 as intermediate circuit 28 or 38. Thus only one high-voltage connection between the high voltage divider 24, 34 or 44 and the test object 23 or 33 is required to be changed between the test series of different test objects. The present invention intends to install the voltage divider 24 or 34 as intermediate circuit and to correct for the systematical error that results from the deviation from the ideal test arrangement.

The measurement errors resulting from the arrangement of the high-voltage divider 24 or 44 as intermediate circuit 28 or 38 are systematic. The correction function u_{K}(t) is the difference between the voltage at the device under test uₚ(t) and the voltage at the high-voltage divider u_{T}(t). Moreover, it contains the electrical parameters of the components of the testing system. It is derived from suitable differential equations such as

uₖ(t)=L diₚ/dt

for the two distinct component arrangements of the high-voltage divider 24 or 44 as subsequent circuit 7 or 17 or high-voltage divider 24 or 44 as intermediate circuit 28 or 38. L is the inductance of the high voltage connection between the high voltage divider 4, 14, 24, 34, 44 and test object 3, 13, 23, 33. The current iₚ flows thought the mentioned high voltage connection. The ideal measured signal u_{e,i}(t) is equal to the real voltage drop over the test object 3, 13, 23, 33.

FIG. 8 shows a testing arrangement with an intermediate circuit 48. Here the correction function u_{K}(t) in the transient recorder conditions the signal u_{e,Z}(t) so that the user obtains an ideal voltage signal u_{e,i}(t) that can then be interpreted accordingly.

### LIST OF IDENTIFIERS

1, 11, 21, 31—impulse generator
2, 12, 22, 32—chopping gap
3, 13, 23, 33—test object
4, 14, 24, 34, 44—high-voltage divider
5, 15, 25, 35, 45—evaluation device/transient recorder
28, 38, 48—intermediate circuit
7, 17—subsequent circuit

What is claimed is:

1. An impulse voltage test system comprising:
(a) a surge voltage generator;
(b) a test object;
(c) a high-voltage divider; and
(d) an evaluation device;
wherein the high-voltage divider is installed as a subsequent circuit and the evaluation device uses a correction algorithm u_{K}(t) of the form uₖ(t)=u_{T}(t)−u_{P}(t) transforming a signal u_{e,N}(t) provided from the high-voltage divider into an ideal measured voltage signal u_{e,i}(t), where u_{T}(t) is the voltage over the high-voltage divider and u_{P}(t) is the voltage over the test object.

2. The impulse voltage test system according to claim 1, further comprising a chopping gap.

3. An impulse voltage test system comprising:
(a) a surge voltage generator;
(b) a test object;
(c) a high-voltage divider; and
(d) an evaluation device;
wherein the high-voltage divider is installed as an intermediate circuit and the evaluation device uses a correction algorithm u_{K}(t) of the form uₖ(t)=u_{T}(t)−u_{P}(t) transforming a voltage signal u_{e,Z}(t) provided from the high-voltage divider into an ideal measured voltage signal u_{e,i}(t), where u_{T}(t) is the voltage over the high-voltage divider and u_{P}(t) is the voltage over the test object.

4. The impulse voltage system according to claim 3, further comprising a chopping gap.

5. The impulse voltage test system according to claim 1, wherein the correction algorithm u_{K}(t) is based on the electrical parameters of the high-voltage connection between the high voltage divider and the test object.

6. The impulse voltage test system according to claim 3, wherein the correction algorithm u_{K}(t) is based on the electrical parameters of the high-voltage connection between the high voltage divider and the test object.

7. An impulse voltage test system comprising:
(a) a surge voltage generator;
(b) a test object;
(c) a high-voltage divider; and
(d) an evaluation device;
wherein the high-voltage divider is installed as a subsequent circuit and the evaluation device uses a correction algorithm u_{K}(t) of the form uₖ(t)=Ldi_{P}/dt transforming a voltage signal u_{e,N}(t) provided from the high-voltage divider into an ideal measured voltage signal u_{e,i}(t) using the form u_{e,i}(t)=u_{K}(t)+u_{e,N}(t), where L is the inductivity of the high-voltage connection between the high-voltage divider and the test object and i_{P}(t) is the current flowing through the high-voltage connection.

8. The impulse voltage system according to claim 7, further comprising a chopping gap.

9. An impulse voltage test system comprising:
(a) a surge voltage generator;
(b) a test object;
(c) a high-voltage divider; and
(d) an evaluation device;
wherein the high-voltage divider is installed as an intermediate circuit and the evaluation device uses a correction algorithm u_{K}(t) of the form uₖ(t)=Ldi_{P}/dt transforming a voltage signal u_{e,N}(t) provided from the high-voltage divider into an ideal measured voltage signal u_{e,i}(t) using the form u_{e,i}(0=u_{e,z}(t)−u_{K}(t), where L is the inductivity of the high-voltage connection between the high-voltage divider and the test object and i_{P}(t) is the current flowing through the high-voltage connection.

10. The impulse voltage system according to claim 9, further comprising a chopping gap.

11. The impulse voltage test system according to claim 1, wherein the evaluation device is a transient recorder.

12. The impulse voltage test system according to claim 3, wherein the evaluation device is a transient recorder.

13. The impulse voltage test system according to claim 7, wherein the evaluation device is a transient recorder.

14. The impulse voltage test system according to claim 9, wherein the evaluation device is a transient recorder.
